(19) United States
(12) Patent Application Publication
(10) Pub. No.: US 2002/0187333 A1
(43) Pub. Date: Dec. 12, 2002

(54) Polyolefin co-extrusion processes and products produced therefrom

(76) Inventor: Jiren Gu, Naperville, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/864,718

(22) Filed: May 23, 2001

(51) Int. Cl. B32B 23/08; B29C 47/06; B32B 31/30

(52) U.S. Cl. 428/308.8; 428/512; 428/513; 264/171.23; 264/173.14

(57) ABSTRACT

The present invention provides a process for effectively extruding a polypropylene polymer onto a cellulosic substrate. In the process, a polypropylene polymer is co-extruded with a polyolefin polymer other than polypropylene so as to stabilize the molten polypropylene polymer layer. Co-extrusion also allows extruding the polypropylene polymer at elevated temperatures so that the polypropylene is oxidized. Thus the polypropylene layer more readily bonds to a substrate without requiring a primer or ozone pretreatment step.

### FIELD OF THE INVENTION

The present invention relates to processes for producing polymer coated substrates, and more particularly to processes for co-extruding polyolefin polymers and products produced therefrom.

### BACKGROUND OF THE INVENTION

Labels, decals and the like are commonly provided as part of a multi-component system. The multi-component system includes label stock, typically formed of a paper or polymeric film substrate. Print or ornamental designs are often applied to an outer surface of the label stock. The opposing surface of the label stock is coated with an adhesive for adhering the label to a surface. To protect the adhesive coating until use, a release liner overlies and adheres to the adhesive layer.

Commercially available release liners typically include a support substrate, such as a polymeric film or polyolefin coated paper. A release layer is applied to one, or both, surfaces of the support substrate. The release layer can include any of a variety of known release agents, such as fluoropolymers, silicones, and the like.

Polyolefin coated paper substrates can include polypropylene or polyethylene coatings. For certain applications, polypropylene is preferred because polypropylene coated papers have better blister resistance at high temperatures as compared to polyethylene coated paper substrates.

Conventional polypropylene, however, is difficult to use in extrusion coating applications because of the lack of web stability. To extrusion coat conventional polypropylene, it must first be blended with low density polyethylene (LDPE). The presence of LDPE in the blend, however, can compromise the heat resistance properties of the polypropylene polymer and as a result, lowers the temperature at which the coated paper will blister. Poor die cut performance at high temperatures can also result.

As an alternative, polypropylene polymers have been specially designed for extrusion coating without blending with LDPE. The resultant polypropylene coated papers can have higher blister temperatures and higher temperature die cut performance than polypropylene/low density polyethylene blend coated paper. However, the specially designed polypropylene can be significantly more expensive.

In addition, for both PP/LDPE blends and polypropylenes specially designed for extrusion applications, the polypropylene cannot typically be extruded at temperatures greater than about 550° F. At higher temperatures, the polypropylene will lose its melt curtain stability. To make polypropylene coated paper substrates, it is desirable to oxidize the polypropylene so that the polypropylene will stick to the paper substrate. Polypropylene oxidation, however, is not significant at these lower temperatures. Thus, whether using PP/LDPE blends or polypropylene alone, some pretreatment step is required to bond the polypropylene coating to the paper substrate. Typical pretreatment steps include ozone treatment of the molten polypropylene and primer treatments of the substrate.

Such pretreatment step can be undesirable. For example, ozone treatments can be very corrosive towards chrome surface chill rolls typically used in extrusion processes. Because of this corrosive effect, the chill rolls may require more frequent resurfacing, which in turn is expensive.

Primers typically used to improve bonding are also expensive, thus adding to the manufacturing cost of such products. In addition, most commercially available primers do not provide effective fiber tear bond strength between the polypropylene and a substrate onto which the polypropylene is extruded. As a result such structures can delaminate.

Still further, the requirement of a primer treated support substrate can limit the uses of the coated substrate because certain premium applications require a primerless substrate. Indeed, primerless polypropylene coated substrates are not currently commercially available.

Still further, polypropylene polymers typically include additives, for example, antioxidants. Thus even for polypropylenes specially designed for extrusion applications and polypropylene/polyethylene blends, there remains an issue of undesired leaching or transfer of such additives from the polypropylene to an adjacent surface. This is particularly problematic in the production of release liners having a silicone based release coating. Certain additives found in many polypropylenes are poisonous to catalysts used to cure silicone release systems.

### SUMMARY OF THE INVENTION

The present invention provides a process in which polypropylene polymers can be readily extruded to form a substantially stable molten polypropylene curtain. Thus, the present invention allows the economic and commercially feasible production of polypropylene coated substrates, without requiring the use of expensive specially designed polypropylene polymers. The invention can also eliminate the need for blending polypropylene with other polymers, which can compromise blister resistance of the polypropylene coated substrate and die cut performance for release liner applications.

In addition, the process of the invention allows the extrusion of polypropylene at significantly higher temperatures than were heretofore possible. In particular, the polymers can be co-extruded at temperatures greater than 550° F., and even as high as 600° F. As a result, the stabilized molten polypropylene curtain can be sufficiently oxidized to promote bonding thereof to a substrate, such as a cellulosic substrate. This in turn can provide economies of manufacture by eliminating the need for pretreatment steps, such as ozone treatment and primers previously required for adequate adhesion between polypropylene and a substrate surface.

In the invention, polypropylene is co-extruded with at least one additional polymer, and preferably another polyolefin, such as polyethylene. One particularly preferred polymer for use in the co-extrusion process is high density polyethylene, although other polyethylene polymers, including low density polyethylene and linear low density polyethylene, may also be used in the present invention.

The polymers are co-extruded onto a supporting substrate, such as a cellulosic substrate, so that the molten polypropylene layer is adjacent a surface of the substrate and is sandwiched between the substrate and the other polymeric layer. This structure provides another benefit of the invention, namely, shielding an adjacent layer (such as a silicone release layer) from migration of additives from the polypropylene.

Although not wishing to be bound by any explanation of the invention, it is currently believed that the presence of the other polymer during co-extrusion stabilizes the polypropylene curtain. In addition, polypropylene can be extruded at elevated temperatures as high as 550° F., and higher, and even upwards of 600° F. The elevated temperatures oxidize the molten polypropylene layer so as to promote bonding thereof to a substrate. This can eliminate the need for pretreatment steps, such as ozone treatment or priming, which in turn can reduce production costs and times. Yet despite the elevated temperatures used to promote polypropylene oxidation, the molten polypropylene curtain remains substantially stable.

The resultant product includes a cellulosic substrate with a co-extruded polymeric layer on a surface thereof. The resultant coated substrates can have blister resistance comparable to that of a polypropylene coating and better than that observed with LDPE/PP blends. In addition, despite the elimination of an ozone and primer pretreatment step, the multi-layered sheet material exhibits good interlaminar bonding such that the adhesive strength between the polypropylene polymer layer and the substrate is greater than the cohesive strength of the cellulosic substrate. Thus the sheet fails cohesively, i.e., within the respective layers, rather than delaminates. The sheet materials are particularly useful as release liners, in which a release material is applied to an outer surface of the co-extruded polymeric layer to form a substrate/co-extruded polymer layer/release coating construction.

### BRIEF DESCRIPTION OF THE DRAWINGS

Having thus described the invention in general terms, reference will now be made to the accompanying drawings, which are not necessarily drawn to scale, and wherein:

FIG. 1 schematically illustrates an exemplary co-extrusion process in accordance with the present invention;

FIGS. 2A and 2B are cross-sectional views of two representative co-extrusion die configurations useful in the present invention;

FIG. 3 is a cross sectional view of an exemplary multi-layer sheet material prepared in accordance with the present invention, illustrating the respective layers thereof;

FIG. 4 is a cross sectional view of another exemplary multi-layer sheet material prepared in accordance with the present invention; and

FIG. 5 is a top view of a label which includes as a component a multi-layer sheet material prepared in accordance with the present invention, with the top layer peeled away for clarity of illustration.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

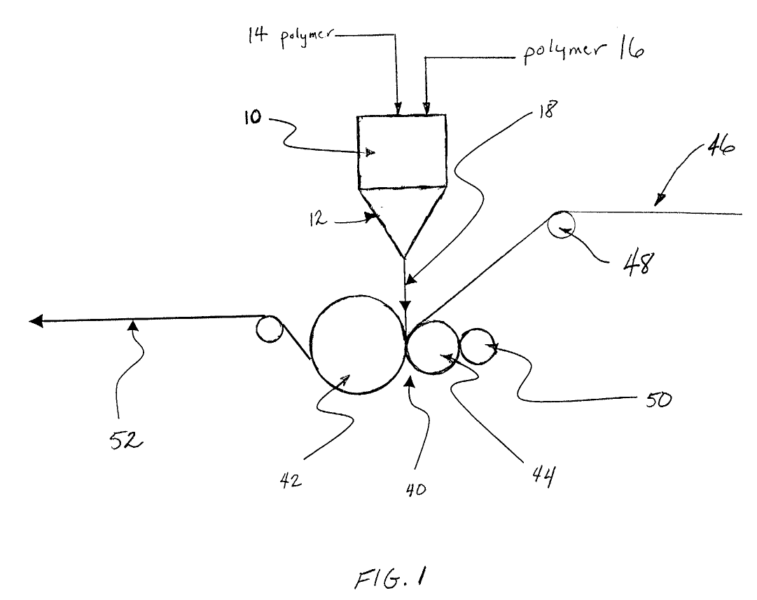

FIG. 1 illustrates an exemplary process for co-extruding polyolefin layers onto a substrate in accordance with the present invention. In particular FIG. 1 illustrates a co-extruder 10 provided with a die head 12, both of which are cooperatively employed for heating and melting at least two polymers, and for co-extruding the polymers to form a continuous co-extruded polymeric sheet or film.

The polymers to be co-extruded in accordance with the present invention are directed from polymer sources 14 and 16, respectively, into the co-extruder. Each of the polymers to be extruded is described in more detail below. Generally at least two polyolefin based polymers are co-extruded in accordance with the present invention, one of which is a polypropylene polymer and the other is preferably a polyethylene polymer.

The polymers are directed into extruder 10 in which the polymers are co-extruded simultaneously via co-extruder 12 to form a continuous co-extruded molten polymeric sheet or film 18. The resultant co-extruded sheet 18 includes at least a polypropylene layer and one other polyolefin layer.

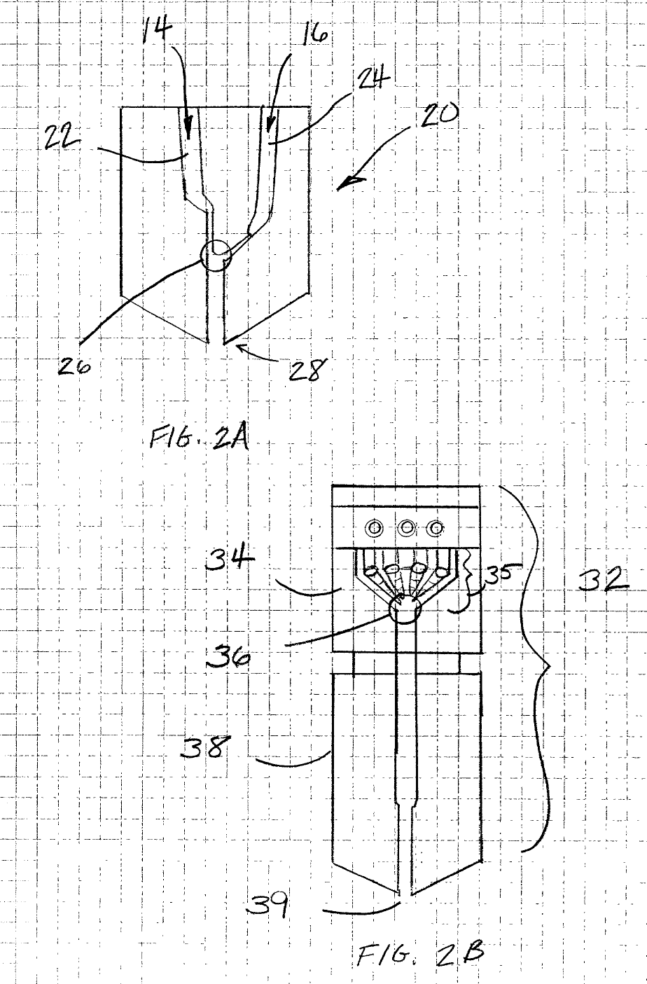

Die head 12 can be any of the conventional die heads known in the art for co-extruding two or more polymeric melts. Two such exemplary die heads are illustrated in cross section in FIGS. 2A and 2B. FIG. 2A illustrates a multimanifold die 20. In a multimanifold die such as that illustrated, the polymers from polymer sources 14 and 16 are directed into the die. Within the die, the polymer melt streams are confined to individual flow channels, designated as 22 and 24, respectively, until they are joined at a region 26 near a die exit 28, and exit the die as a multilayer molten sheet material 18.

FIG. 2B illustrates a co-extrusion coating feedblock and monolayer die, designated generally as 32. In the feedblock method, the polymers enter an adapter upstream of a die, known as a feedblock 34, in which the polymer melt streams 35 are combined in a region 36 and arranged to flow together in layers moving in a laminar flow. The multilayer stream is directed from the feedblock 34 and into a single manifold die 38, through which the polymers flow and exit via die exit 39 as a multilayer molten film or sheet material 18.

FIG. 2A illustrates a two layer co-extruded film, and FIG. 2B illustrates a five layer co-extruded film. However, one skilled in the art will appreciate that the co-extruded films of the invention can have varying numbers of layers. In addition, the die configurations of FIGS. 2A and 2B are illustrative only, and the skilled artisan will appreciate that other types of equipment as known in the art to be useful for co-extruding multiple polymer melts can be used in accordance with the present invention.

The temperature at which the polymers co-extruded under pressure through the die is controlled so as to oxidize the molten polypropylene layer. This in turn promotes bonding of the co-extruded film, and in particular the polypropylene layer, to a substrate without requiring a pretreatment step. Preferably the polymers are co-extruded at a temperature at which the polypropylene polymer will substantially oxidize, generally at a temperature greater than about 550° F., and more preferably at a temperature of about 600° F.

Other co-extrusion conditions, such as pressure, line speed, and the like, will vary depending upon various factors, such as the polymers used, and can be readily determined by the skilled artisan. For example, the extrusion rate from extruder 12 is typically coordinated with the running speed of a substrate to which the co-extruded layer is applied, which can run at conventional speeds as known in the art. Another advantage of the invention results from stabilizing the polypropylene layer. Because the polypropylene layer is stable, line speeds are not adversely affected, and indeed the process can be conducted at line speeds as high as 1000 feet per minute.

The amount of the polymers present in the resultant co-extruded layer can vary, with respect to a substrate to which the polymers are applied as discussed below, and also with regard to one another. Generally, the co-extruded polymers are extruded in an amount selected so that the polymers make up the minority component of the overall weight of a resulting laminate material. In addition, typically the amounts of the co-extruded polymers are selected so that the polypropylene polymer is the majority component of the co-extruded layer. This can be advantageous for applications requiring high temperature performance, imparted by the presence of a majority polypropylene component. Advantageously for high temperature performance, the polypropylene polymer comprises at least about 80 weight percent or more of the co-extruded film.

The co-extruded sheet 18 exits the die and is directed to a laminating nip 40 formed by cooperating rotating chill roll 42 and pressure roll 44. A cellulosic substrate 46 is also directed by a roll 48 into nip 40 substantially simultaneously with the molten co-extruded sheet 18. The cellulosic substrate enters the nip so that the polypropylene layer is immediately adjacent a surface thereof. Thus the polypropylene layer is sandwiched between the cellulosic substrate and the other polyolefin layer.

A primary advantage of the present invention is the ability to extrude a stable molten polypropylene sheet and effectively oxidize the same so as to minimize or eliminate prior processing steps, such as priming and ozone treatment, previously required to adhere the polypropylene layer to a substrate surface. Thus the process of the invention can eliminate the need to activate a substrate surface, using corona treatment, chemical priming, chemical etching, ozone injection, flame treatment and the like. This can provides many benefits, including increased line speeds and reduced costs.

The resultant structure with cellulosic layer 46 and co-extruded polymer layer 18 is then directed through laminating nip 40. Chill roll 42 can be cooled using conventional techniques, for example by passing a cooling medium (e.g., water) through the interior thereof. The temperature of chill roll 42 is generally maintained from about 15° C. to about 30° C. Temperatures can vary depending upon various factors including the polymer used. Chill roll 42 is typically a cylindrical metal chill roll with a chromium coating applied to the outer surface thereof. The cylindrical roll can be formed of a variety of metals, such as the various steels, aluminum, and the like, as well as alloys thereof. The surface of chill roll 42 is typically smooth, as is known in the art.

The laminating pressure between pressure roll 44 and chill roll 42 is adjusted and maintained by contacting a pressure back-up roll 50 against the pressure roll 44. The pressure roll 44 is typically a rubber covered roll having a Shore A durometer hardness ranging from about 70 to about 95. Other materials having a similar hardness and resiliency as rubber may optionally be used to form the pressure roll 44. The pressure back-up roll 50 urges the pressure roll 44 toward the chill roll 42 and may itself be cooled by passing a cooling medium such as water through the interior thereof. The pressure between the pressure roll 44 and chill roll 42 as applied by the pressure back-up roll 44 can fall within conventional ranges and can be readily determined by the skilled artisan.

As the structure passes through the laminating nip 40, the polymeric co-extruded layer 18 solidifies and adheres to cellulosic layer 46 to form a coherent structure. The resultant laminate 52 can then be directed to a take up roll for storage, or alternatively directed downstream for additional processing.

Variations of the extrusion processing conditions will be appreciated by those skilled in the art, such as increasing or decreasing web speed, varying the thickness of co-extruded polymeric layer 18, modification of nip pressure and/or pressure roll hardness, and other process conditions.

In addition, polymeric co-extruded layer 18 can include more than two co-extruded polymeric layers. For example, in one advantageous embodiment of the invention, the co-extruded layer 18 includes an outer polypropylene layer in addition to the polypropylene layer directly adjacent the cellulosic substrate. The resultant co-extruded film has a polypropylene layer/polyolefin layer/polypropylene layer structure. This configuration provides the benefits of stable extrusion of polypropylene at temperatures sufficient to oxidize the polypropylene as well as improved high temperature performance because of the presence of a relatively high melt polymer not only adjacent the cellulosic substrate but also as the outer polymer layer of the co-extruded sheet. Such sheet materials are useful for applications other than release liners which require high temperature performance. One non-limiting example is that of a packaging material used to package microwaveable food. Because of the high temperature performance of the resultant package, the package can be readily microwaved without significant softening of the outer polymer layer.

As another example, the process of the invention can include the additional step of directing the cellulosic/polymeric co-extrusion laminate exiting nip 40 to a downstream operation to apply a polyolefin coating to the other surface of the coated substrate. The additional polyolefin coating can be a monolayer or a co-extruded layer, and preferably can be a co-extruded layer including polypropylene/polyolefin layers prepared as described above with reference to FIG. 1.

One particularly preferred use of the multi-layer sheet materials of the invention is as a support substrate for release liners. Thus, the present invention also includes the optional step of applying a suitable release coating to one or both surfaces of the multi-layer sheet material.

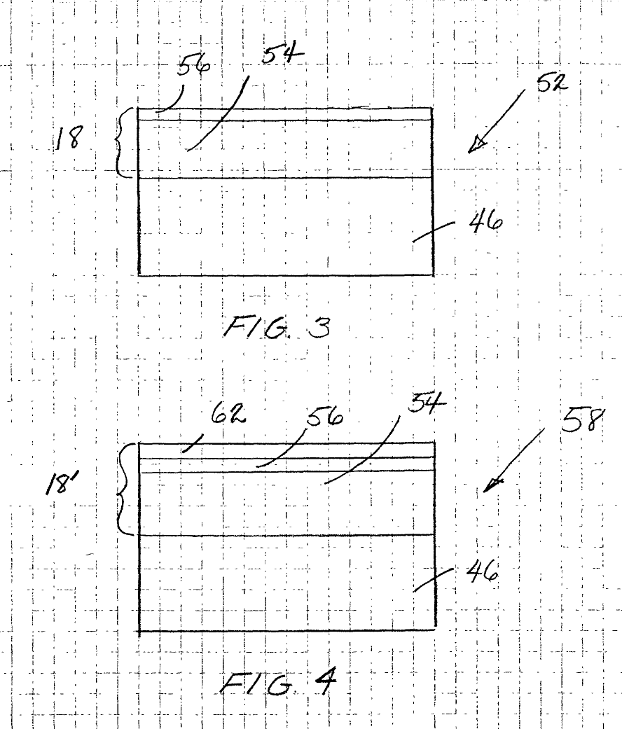

FIG. 3 is a cross sectional view of a representative multi-layer sheet material 52 of the invention. Sheet material 52 includes a cellulosic layer 46 bonded to a co-extruded polymeric layer 18. The co-extruded polymeric layer 18 includes a polypropylene layer 54 adjacent a surface of the substrate 46. The co-extruded polymeric layer 18 also includes at least one additional outer polyolefin layer 56.

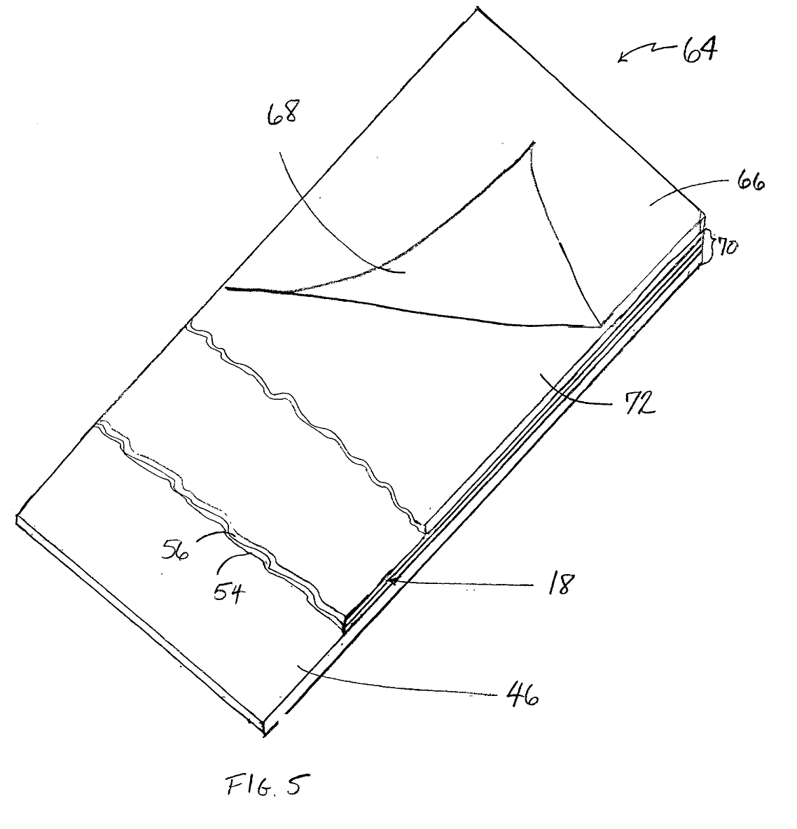

The co-extruded layer 18 may also include additional layers. For example, as shown in FIG. 4, the multi-layer sheet materials can include a co-extruded layer 18′ having at least three polymeric layers. The co-extruded layer 18′ includes polypropylene layer 54 adjacent cellulosic substrate 46 and polymeric layer 56 adjacent polypropylene layer 54. In addition, co-extruded layer 18′ also includes at least one additional polymeric layer 62 overlying and adhered to polymeric layer 56. Although a three layered co-extruded structure is shown, the skilled artisan will appreciate that the co-extruded polymeric layer can include additional polymeric layers. Preferably the outermost layer thereof, as exemplified by layer 62 in FIG. 4, is also a polypropylene layer so as to impart improved heat resistance to the structure, as compared to a laminate having an outer polyethylene layer. However, the invention is not so limited and in certain applications it may be useful to provide outer polymeric layers in the co-extrusion other than polypropylene, or even other than a polyolefin. For example, other relatively high temperature resistance polymers, such as polyesters, can be used in the production of a co-extruded material with outer layer 62.

The thickness of the cellulosic layer 46 and the co-extruded polymeric layer 18 to one another can vary, although generally the thickness of the cellulosic substrate is greater than the thickness of the co-extruded layer 18. Typically cellulosic layer 46 has a thickness ranging from about 20 micrometers to about 300 micrometers, and preferably from about 25 micrometers to about 200 micrometers. Cellulosic layers having a thickness outside of these ranges can also be used in accordance with the present invention, although, as noted above, advantageously the thickness of cellulosic layer 46 is greater than the thickness of the co-extruded polymeric layer.

The thickness of the co-extruded polymeric layer 18 can also vary. The thickness of co-extruded polymer layer 18 typically ranges from about 10 micrometers to about 75 micrometers, and preferably from about 15 micrometers to about 50 micrometers. Again, however, the co-extruded polymeric layer can have a thickness falling outside of this range.

In addition, the relative thickness of the polymeric layers 54 and 56 of the co-extruded layer 18 to one another can vary. Generally the polypropylene layer 54 is thicker than the outer polyolefin layer 56. In particular, advantageously polypropylene layer 54 comprises at least about 80 weight percent or more of the total weight of the co-extruded sheet material 18.

Cellulosic layer 46 is preferably a paper substrate. Any of the types of papers having sufficient tensile strength to be handled in conventional paper coating and treating apparatus can be employed as the substrate layer. The paper used depends upon the end use and particular personal preferences. Examples of the types of paper which can be used include paper, clay coated paper, glassine, paperboard from straw, bark, wood, cotton, flax, cornstalks, sugarcane, bagasse, bamboo, hemp, and similar cellulose materials prepared by such processes as the soda, sulfite or sulfate (Kraft) processes, the neutral sulfide cooking process, alkali-chlorine processes, nitric acid processes, semi-chemical processes, etc. Although paper of any weight can be employed as a substrate material, paper having basis weights ranging from about 20 to about 300 grams per square meter (gsm), and preferably from about 25 to about 200 gsm, may be used.

The respective polymeric layers of co-extruded polymeric layer 18 can be formed of any of the types of polymeric resins useful in extrusion coating or laminating. Particularly preferred are olefinic polymers, but the invention is not so limited and other polymers can be used as well.

Various polypropylene polymers known to the skilled artisan can be used as layer 54 in the invention. In general, the polypropylene component can be an isotactic or syndiotactic polypropylene homopolymer, copolymer, or terpolymer with the most preferred being in the form of a homopolymer. As discussed above, the present invention permits successful extrusion coating of polypropylenes other than polymers specially designed for extrusion processing. For example, polypropylenes designed for injection molding can be used. However the invention is not so limited, and polypropylenes specially designed for extrusion coating can also be used in accordance with the present invention. Impact modified polypropylenes as known in the art may also be used. These polymers are commercially available.

Polymer layer 56 also preferably is formed of a polyolefin, and more preferably a polyethylene, including ethylene homopolymers, copolymers, and terpolymers. Various types of polyethylene are useful, including low density polyethylene, high density polyethylene and linear low density polyethylene (LLDPE). Such polymers are also commercially available.

The olefinic polymers can be produced from any of the well known processes, including, without limitation, Ziegler-Natta catalyst processes, single site or metallocene catalyst processes, and the like. Metallocene polymers can impart high tear strength properties to the laminate. Metallocene catalyst polyethylene can be characterized by controlled geometry, such as substantially precise placement of a comonomer into the ethylene backbone. Various alpha-olefins are typically copolymerized with ethylene in producing metallocene resins, including higher alpha-olefins such as butene, hexene, 4-methyl-1-pentene, and octene. The comonomer is typically present in an amount of less than about 20% by weight. Examples of suitable commercially available metallocene catalyst polymers include the EXACT polymers available from the Exxon Chemical Company (ranging in densities from about 0.80 to about 0.920 g/cc); the Affinity polymers available from the Dow Chemical Company (ranging in densities from about 0.80 to about 0.920 g/cc); and the Engage resins from DuPont/Dow Elastomers (ranging in densities from about 0.80 to about 0.910 g/cc).

Other polymeric resins useful in the invention and which can be co-extruded with polypropylene include without limitation polyesters, such as polyethylene terephthalate, polybutylene terephthalate, and the like; polyamides, such as polyhexamethylene adipamide, polycaproamide, and the like; polyurethanes; as well as co- and ter-polymers of the same.

Ionomers as known in the art can also be used in accordance with the present invention as a layer in the co-extruded polymeric layer 18. The term “ionomer” as used herein is defined as a metal-containing ionic copolymer obtained by the reaction between ethylene or an alpha-olefin with an ethylenically unsaturated monocarboxylic acid such as acrylic or methacrylic acid wherein at least 10% of the carboxylic acid groups are neutralized by an alkali metal ion, and having a melting point range of from about 80° C. to 120° C. Ionomers are commercially available from E. I. DuPont De Nemours & Company under the name “SURLYN.” Reference is also made to U.S. Pat. No. 3,264,272, which is hereby incorporated by reference in its entirety. This patent describes various types of ionomer resins that may be used in the practice of the present invention.

In addition, blends or mixtures of suitable polymers such as described above can also be used.

Various additives, pigments, dispersing aids, adhesion promoters, lubricants, fillers, antioxidants, and the like may be present in the polymeric layers of co-extruded layer 18. For example, a polymer can be blended with fillers such as talc, calcium carbonate, and the like prior to extrusion to form co-extruded layer 18.

Turning again to FIG. 3, co-extruded polymeric layer 18 is bonded to cellulosic layer 46 to thereby form a unitary multi-layer composite laminate structure 52. The co-extruded polymeric layers can impregnate the cellulosic substrate. Generally, however, the co-extruded polymers do not substantial complete impregnate into the adjacent cellulosic layer 46.

In addition, despite the elimination of an ozone and primer pretreatment step, the multi-layered sheet material exhibits good interlaminar bonding. The resultant multi-layer sheet material 52 can have sufficient adhesion between the various layers so that the laminate fails cohesively, rather than delaminating. Stated differently, the sheet material can have a destructive bond, i.e., bond failure is within the cellulosic layer itself as exemplified by a fiber tear bond of the polypropylene with the paper, rather than between layers. This is in contrast to multi-layer film structures prepared by laminating preformed films to one another, which typically exhibit bond failure between the respective layers, i.e., delaminate.

FIG. 5 illustrates one useful application for the laminates of the invention. In particular FIG. 5 illustrates a label 64 incorporating a release liner in which the support substrate includes a multi-layer sheet material 52 of the invention. In general, labels are multi-component structures which typically include labelstock 66, an adhesive layer 68 and a release liner 70. Release liner 70 includes a release layer 72 on a surface a multi-layer sheet material 52 as the support substrate. The support substrate comprises a cellulosic layer 46 and a co-extruded layer 18 with polypropylene layer 54 and polymeric layer 56, as described above. Labelstock 66 may optionally have a design element incorporated therein, for example, as printed indicia on a surface thereof.

Release layer 72 can include any of the types of release agents known in the art which impart release properties to a substrate. For example, the release layer 72 can be a coating of a release agent, such as a fluoropolymer, silicone, chromium complexes of long chain fatty acids, and the like. Typically, such release agents are cured by any of several techniques, including the use of either heat or electromagnetic radiation, such as ultraviolet (UV), electron beam, and the like. Release layer 72 can also be cured by evaporative processes as known in the art, i.e., dried to remove solvent. Exemplary release agents include without limitation SYL-OFF® 294 with Dow Corning 176 Catalyst, commercially available from Dow Corning; UV9315 with UV9310C catalyst, commercially available from General Electric Silicones, and Quilon®, commercially available from E. I. DuPont. Release layer 72 has a thickness sufficient to impart the desired release properties, typically ranging from about 0.02 micrometers to about 1.6 micrometers, although amounts outside this range may also be used.

In use, labelstock 66 and adhesive layer 68 can be readily pulled away and removed from release layer 72, as indicated. The labelstock can then be adhered via adhesive layer 68 to a suitable surface. The labelstock can be supplied in various forms, such as sheet materials, a supply of roll labels, and the like. In addition, labelstock can have a design applied to a surface thereof (for example by printing) or alternatively can be cut or perforated about the perimeter of a design element to allow just the design to be pulled away and removed from the release material.

To make a product such as that illustrated in FIG. 5, an adhesive layer can be applied to the exposed surface of release layer 72. The adhesive layer/release liner composite structure can thereafter be directed into a face-to-face relationship with a suitable substrate (such as labelstock 66) to form a release liner/adhesive/substrate structure such that the adhesive layer is sandwiched between the substrate and release liner sheet.

The adhesive layer can be formed of various suitable conventional adhesives known in the art, and preferably is a pressure sensitive adhesive. Pressure sensitive adhesives in dry form (substantially solvent free except for residual solvent) are typically aggressively and permanently tacky at room temperature (e.g., from about 15 to about 25° C.) and firmly adhere to a variety of surfaces upon contact without the need for more than manual pressure. Such adhesives typically do not require activation by water, solvent or heat to exert a strong adhesive holding force towards materials such as paper, glass, plastics, wood, and metals. Exemplary pressure sensitive adhesives include rubber-resin materials, polyolefins, acrylics, polyurethanes, polyesters, polyamides, and silicones. The pressure sensitive adhesive may be solvent-coatable, hot-melt coatable, radiation curable (for example, by electron beam or ultraviolet radiation), and water based emulsion type adhesives, all as well known in the art. Specific examples of pressure sensitive adhesives include polyolefin-based polymers and copolymers, such as ethylene vinyl acetate copolymers; acrylic-based adhesives, such as isooctyl acrylate/acrylic acid copolymers and tackified acrylate copolymers; tackified rubber-based adhesives, such as tackified styrene-isoprene-styrene block copolymers, tackified styrene-butadiene-styrene block copolymers and nitrile rubbers, such as acrylonitrile-butadiene; and silicone-based adhesives, such as polysiloxanes.

Adhesive layer 68 can be a single layer of a suitable adhesive material; alternatively, adhesive layer 68 can include multiple layers of adhesive materials. Adhesive layer 68 can also be a substantially continuous or discontinuous layer.

Exemplary substrates useful as labelstock 66 include, without limitation, polymeric substrates, such as polymer films, polymer foams, sheets formed of synthetic staple fibers and/or filaments, and the like; cellulosic substrates, such as paper substrates, woven, knit, netted or nonwoven fabric substrates formed of natural fibers and/or filaments, and the like; substrates including both polymeric and cellulosic components, for example, sheets formed of a blend or mixture of synthetic and cellulosic staple fibers and/or filaments; metal foils; and the like. The substrate can also be a laminate in accordance with the present invention.

Advantageously a surface of the labelstock opposite the adhesive layer is rendered receptive to printed indicia using techniques known in the art, such as corona treatment, application of an additional layer to the substrate surface which is receptive to printed indicia, and the like.

Alternatively, the adhesive may be sandwiched between two release liners to form an unsupported adhesive construction.

The present invention will be further described by the following non-limiting examples.

### EXAMPLE

Polypropylene commercially available from Phillips Sumika as FB99A and high density polyethylene (HDPE) commercially available from Eastman Chemical Co. as Eastcoat 2004 are co-extruded at a melt temperature of 600° F. onto a bleached kraft paper from Boice Cascade. No ozone treatment or primer is used. The polymers are co-extruded so that the polypropylene layer is adjacent the kraft paper. The polypropylene coating weight is 12 grams per square meter (gsm) and the HDPE coating weight is 6 gsm. A gloss chill roll is used and the extrusion line speed is 800 feet per minute (fpm). Both sides of the paper are coated under these conditions.

Bond strength and failure mode of the resultant product are evaluated. The result is fiber tear bond of polypropylene with the paper.

Blister resistance is also evaluated at various temperatures and compared with a product that includes a 80:20 polypropylene/low density polyethylene (PP:LDPE) blend coating on kraft paper. The results are set forth below and demonstrate the improved blister resistance of the invention:

| Oven temperature | | |
|---|---|---|
| ° C. (° F.) | Invention | PP/LDPE 80:20 blend |
| 140 (284) | no blister | no blister |
| 155 (311) | no blister | blister |
| 165 (320) | no blister | blister |

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A process for producing polymer coated substrates, comprising:
co-extruding a molten polypropylene polymer layer and a molten polymer layer of a polyolefin polymer other than polypropylene selected to stabilize the molten polypropylene polymer layer to allow extrusion thereof, directly onto a surface of a cellulosic substrate so that the molten polypropylene polymer layer is disposed adjacent the cellulosic substrate, under conditions sufficient to oxidize the molten polypropylene layer to promote bonding thereof to the cellulosic substrate without a pretreatment step; and
cooling said molten co-extruded polymer layers to form a coherent structure.

2. The process of claim 1, wherein the co-extrusion step comprises co-extruding the polymer layers under conditions sufficient to oxidize the molten polypropylene layer to provide an adhesive strength between the polypropylene polymer layer and the cellulosic substrate that is greater than the cohesive strength of the cellulosic substrate.

3. The process of claim 1, wherein the co-extrusion step comprises co-extruding the polymer layers at a temperature greater than about 550° F.

4. The process of claim 3, wherein the co-extrusion step comprises co-extruding the polymer layers at a temperature of about 600° F.

5. The process of claim 1, further comprising applying pressure to the molten polyolefin/molten polypropylene/cellulosic substrate structure sufficient to cause the molten polypropylene to impregnate into at least a portion of the cellulosic substrate after the co-extruding step.

6. The process of claim 5, wherein the pressure applying step comprises directing the molten polyolefin/molten polypropylene/cellulosic substrate structure into a nip formed by a pair of cooperating rolls.

7. The process of claim 6, wherein the cooperating rolls include a pressure roll in direct contact with the cellulosic substrate and a chill roll in direct contact with the molten polyolefin polymer layer.

8. The process of claim 7, wherein the pressure applying step and the cooling step occur substantially simultaneously.

9. The process of claim 1, wherein the polyolefin polymer is a polyethylene polymer.

10. The process of claim 9, wherein the polyethylene polymer is selected from the group consisting of high density polyethylene, low density polyethylene, linear low density polyethylene and copolymers, terpolymers, and blends thereof.

11. The process of claim 10, wherein the polyethylene polymer is high density polyethylene.

12. The process of claim 10, wherein the polyethylene polymer is low density polyethylene.

13. The process of claim 1, wherein the polypropylene polymer is selected from the group consisting of polypropylene homopolymers, polypropylene co- and terpolymers, and polypropylene dominate blends.

14. The process of claim 13, wherein the polypropylene polymer is a polypropylene homopolymer.

15. The process of claim 1, wherein the cellulosic substrate is a paper substrate.

16. The process of claim 1, wherein said co-extruding step comprises co-extruding said polypropylene polymer, said polyolefin polymer and at least one additional polymer so as to sandwich said polyolefin polymer between said polypropylene polymer and said additional polymer.

17. The process of claim 16, wherein said additional polymer is polypropylene.

18. The process of claim 1, wherein the polypropylene layer comprises the majority component of said co-extruded polymer layer.

19. A process for producing co-extruded polyolefin coated cellulosic substrates useful as release liners, comprising:
co-extruding a molten polypropylene polymer layer and a molten polyethylene polymer layer directly onto a surface of cellulosic substrate so that the molten polypropylene polymer layer is disposed adjacent the cellulosic substrate, at a temperature greater than about 550° F. to oxidize the molten polypropylene layer to promote bonding thereof to the cellulosic substrate without a pretreatment step; and
cooling said molten polymer layers to form a coherent structure.

20. The process of claim 19, wherein said polyethylene is high density polyethylene.

21. The process of claim 19, wherein said polyethylene is low density polyethylene.

22. The process of claim 19, wherein said co-extruding step comprises co-extruding said polypropylene polymer, said polyethylene polymer and at least one additional polymer so as to sandwich said polyethylene polymer between said polypropylene polymer and said additional polymer.

23. The process of claim 22, wherein said additional polymer is polypropylene.

24. The process of claim 19, wherein the polypropylene layer comprises the majority component of said co-extruded polymer layer.

25. A multi-layer sheet material comprising:
a cellulosic substrate; and
a co-extruded polymer layer on a surface of the cellulosic substrate comprising a polypropylene polymer layer adjacent the cellulosic substrate and a polyolefin polymer layer formed of a polymer other than polypropylene overlying said polypropylene polymer layer,
wherein the multi-layer sheet material has an adhesive strength between the polypropylene polymer layer and the cellulosic substrate that is greater than the cohesive strength of the cellulosic substrate.

26. The multi-layer sheet material of claim 25, wherein said polypropylene polymer layer and said polyolefin polymer layer are co-extruded directly onto a surface of the cellulosic substrate.

27. The multi-layer sheet material of claim 26, wherein said polypropylene layer penetrates into at least a portion of said cellulosic substrate layer.

28. The multi-layer sheet material of claim 25, wherein and said polyolefin polymer layer comprises high density polyethylene polymer.

29. The multi-layer sheet material of claim 25, wherein and said polyolefin polymer layer comprises low density polyethylene polymer.

30. The multi-layer sheet material of claim 25, wherein the polypropylene layer comprises the majority component of said co-extruded polymer layer.

31. The multi-layer sheet material of claim 30, wherein the polypropylene layer comprises at least about 80 weight percent of said co-extruded polymer layer.

32. The multi-layer sheet material of claim 25, further comprising at least one additional polymeric layer overlaying said polyolefin layer.

33. The multi-layer sheet material of claim 32, wherein said at least one additional polymeric layer overlaying said polyolefin layer is a polypropylene layer.

34. A co-extruded polymer coated sheet material, comprising:
a cellulosic substrate; and
polypropylene/polyethylene/polypropylene layer co-extruded directly onto a surface of the cellulosic substrate so that one of the polypropylene layers is adjacent a surface of the cellulosic substrate,
wherein the polypropylene layer adjacent the cellulosic substrate comprises the majority component of said co-extruded layers and wherein the sheet material has an adhesive strength between the polypropylene layer and the cellulosic substrate that is greater than the cohesive strength of the cellulosic substrate.

35. A release liner comprising:
a cellulosic substrate;
a co-extruded polymer layer on said cellulosic substrate comprising a polypropylene polymer layer adjacent a surface of said porous substrate and a polyolefin polymer layer formed of a polymer other than polypropylene overlying said polypropylene polymer layer, wherein the adhesive strength between the polypropylene polymer layer and the cellulosic substrate is greater than the cohesive strength of the cellulosic substrate; and
a release coating on an outer surface of the co-extruded polymer layer.

36. The release liner of claim 35, wherein said polypropylene layer penetrates into at least a portion of said cellulosic substrate layer.

37. The release liner of claim 35, wherein and said polyolefin polymer layer comprises high density polyethylene polymer.

38. The release liner of claim 35, wherein and said polyolefin polymer layer comprises low density polyethylene polymer.

39. The release liner of claim 35, wherein the polypropylene layer comprises the majority component of said co-extruded polymer layer.

40. The release liner of claim 39, wherein the polypropylene layer comprises at least about 80 weight percent of said co-extruded polymer layer.

41. The release liner of claim 35, further comprising at least one additional polymeric layer overlaying said polyolefin layer.

42. The release liner of claim 41, wherein said at least one additional polymeric layer overlaying said polyolefin layer is a polypropylene layer.

43. A release liner comprising:
a cellulosic substrate;
a polypropylene/polyethylene/polypropylene layer co-extruded directly onto a surface of the cellulosic substrate so that one of the polypropylene layers is adjacent a surface of the cellulosic substrate,
wherein the polypropylene layer adjacent the cellulosic substrate comprises the majority component of said co-extruded layers and wherein the sheet material has an adhesive strength between the polypropylene layer and the cellulosic substrate that is greater than the cohesive strength of the cellulosic substrate; and
a release coating on an outer surface of the co-extruded polymer layer.
